(19) United States
(12) Patent Application Publication
(10) Pub. No.: US 2017/0163813 A1
(43) Pub. Date: Jun. 8, 2017

(54) MODIFICATION OF AUDIO SIGNAL BASED ON USER AND LOCATION

(71) Applicant: Lenovo (Singapore) Pte. Ltd., New Tech Park (SG)

(72) Inventors: Bryan Loyd Young, Tualatin, OR (US); Gary David Cudak, Wake Forest, NC (US); John Scott Crowe, Durham, NC (US); Jennifer Lee-Baron, Morrisville, NC (US); Amy Leigh Rose, Chapel Hill, NC (US); Nathan J. Peterson, Oxford, NC (US)

(21) Appl. No.: 14/958,508

(22) Filed: Dec. 3, 2015

(51) Int. Cl. H04M 3/56; G10L 21/0364

(52) U.S. Cl. CPC H04M 3/568; G10L 21/0364

(57) ABSTRACT

In one aspect, a device includes a processor and storage accessible to the processor. The storage bears instructions executable by the processor to receive at least one audio signal, identify one or more of a user associated with at least one received audio signal and a location of the user, and modify at least one received audio signal based at least in part on identification of one or more of the user and the location.

### FIELD

The present application relates generally to modification of audio signals based on users and locations.

### BACKGROUND

Speaking with emphasis or loudly may be sometimes needed when participating in a conference call owing to a number of factors, such as microphone quality and speaker quality of devices being used to engage in the call. However, sometimes this can be considered offensive or insulting, depending on the culture from which one of the participants hails. Furthermore, owing to differences in accents even if speaking the same language, some words spoken by one participant may be difficult to discern by another participant. As recognized herein, there are currently no adequate solutions to the foregoing telephonic communication issues.

### SUMMARY

Accordingly, in one aspect a device includes a processor and storage accessible to the processor. The storage bears instructions executable by the processor to receive at least one audio signal, identify one or more of a user associated with at least one received audio signal and a location of the user, and modify at least one received audio signal based at least in part on identification of one or more of the user and the location.

In another aspect, a method includes receiving at least one audio signal at a device, identifying one or more of a person associated with at least one received audio signal and a location of the person, and altering at least one received audio signal based at least in part on the identifying of one or more of the person and the location.

In still another aspect, an apparatus includes a processor and storage accessible to the processor. The storage bears instructions executable by the processor to facilitate a telephonic conference and alter at least a portion of audio for the telephonic conference based at least in part on one or more of a conference participant and a location of a conference participant.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3 and 4 are flow charts showing example algorithms in accordance with present principles;

FIGS. 5 and 6 are example data tables in accordance with present principles; and

FIGS. 7 and 8 are example user interfaces (UIs) in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C+, and can be stored on or transmitted through a computer-readable storage medium (e.g., that may not be a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

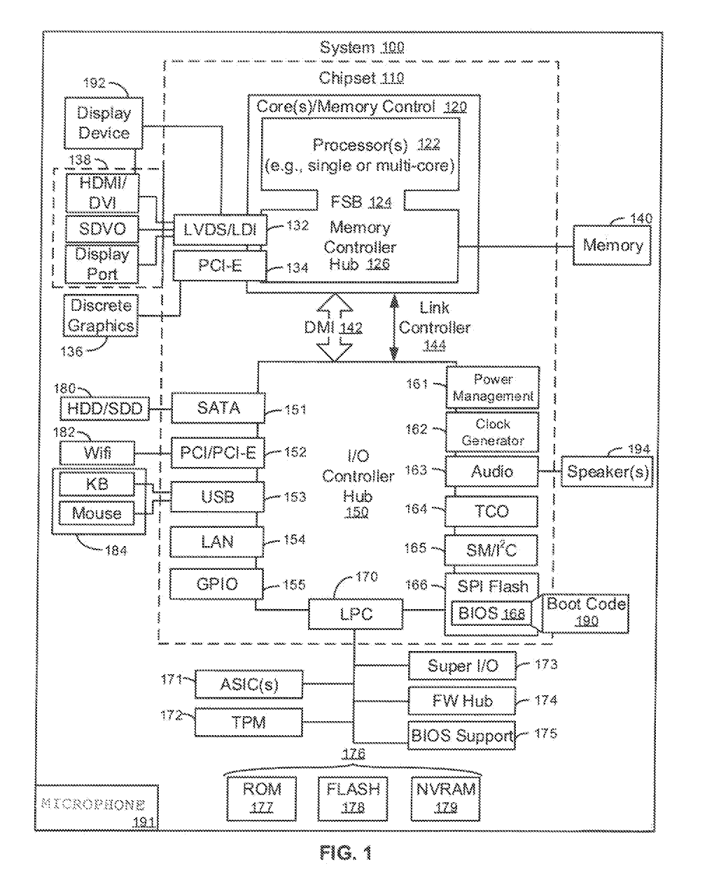

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX® or Playstation®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video. HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that may not be transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still in reference to FIG. 1, also shown coupled to the system 100 is an audio receiver/microphone 191 that provides input to the processor 122 based on, e.g., a user providing audible input to the microphone such as during a telephonic communication. Additionally, though now shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

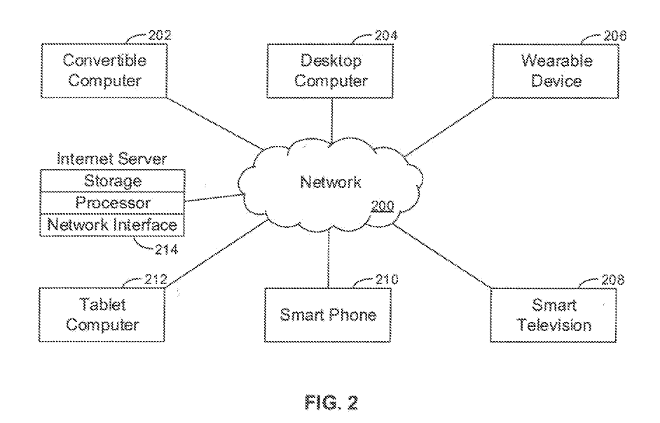

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

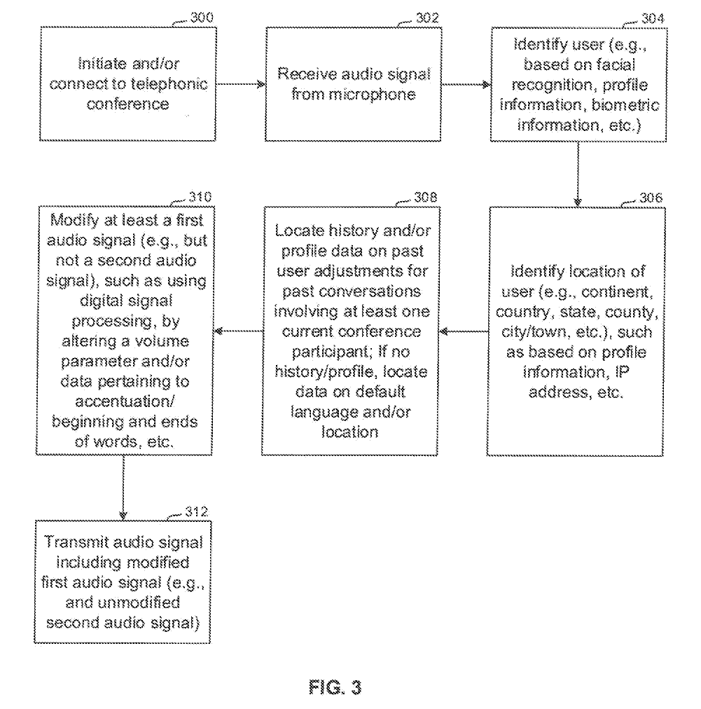

Now referring to FIG. 3, it shows example logic that may be undertaken by a device (referred to when describing FIG. 3 as the “present device”), such as the system 100 and/or a telephonic communication-enabled device, in accordance with present principles to alter an audio signal from a microphone on the present device, such as when a user may have set their device to alter a parameter for audio signals generated from input when they speak during a telephonic conference. Beginning at block 300, the logic initiates and/or connects to a telephonic conference, such as a wireless telephone conference or a voice over internet protocol (VOIP) telephone conference. The logic then moves to block 302 where the logic receives one or more audio signals from a microphone coupled to and/or in communication with the present device, such as audio signals generated by a microphone based on words spoken by a user of the present device and detected by the microphone.

Responsive to receiving one or more audio signals at block 302, the logic moves to block 304 where the logic may identify a user that provided the input to the microphone which in turn generated audio signals based on the input. The logic may identify the user a number of ways, such as based on the user being associated with the particular device to which the input was directed, based on a profile associated with the user and identified by the present device based on receipt from the user of profile identifying information, based on facial recognition such as if the present device gathered an image of the user and performed facial recognition by comparing the gathered image to a template, based on biometric information received at the present device such as fingerprint data received at a fingerprint reader on the present device, etc.

From block 304 the logic then moves to block 306. At block 306 the logic may identify a location of the user from which the audio input was received. The location that is identified may be a continent, a country, a state, a county, a city, a town, other geographic region, etc. Regardless, it may be identified based on profile information such as the profile mentioned in the paragraph above, based on an IP address accessible to and associated with the present device (and/or being used by the present device), etc.

After block 306, in some example embodiments the logic may, at block 308, locate history and/or profile data associated with the user, and/or associated with another identified participant in the telephonic conference for which history and/or profile data has been established and is accessible. The history and/or profile data may pertain to settings established during past conversations involving at least one of the participants in the telephonic conference, such as a setting to output audio for the particular participant at a particular volume level, a setting to accentuate one or more portions of a word spoken by the particular participant, a setting to output audio for the particular participant using a particular voice (e.g., Darth Vader) and/or accent, settings applied based on the particular participant being at a specific location, etc. Also at block 308, if no such history and/or profile data is accessible for the particular participant, the logic may locate data for default settings to apply when processing audio signals for the particular participant (and/or other participants in the telephonic conference), such as may be identified based on the location of the particular participant as will be set forth further below.

After block 308, or directly from block 306 if a given set of instructions being executed by the present device do not instruct the present device to execute what was discussed above in reference to block 308, the logic moves to block 310. Based on the information identified and/or accessed at blocks 304-308, the logic at block 310 modifies at least a first audio signal from the microphone on the present device, although it is to be understood that in some instances only certain portions of the user's audio input is to be modified and hence the first audio signal may be modified (such as one representing a beginning syllable of a word spoken by the user, or a portion corresponding to audio input being spoken at a first volume level) while a second audio signal may not be modified (such as one pertaining another syllable in the word, or another portion corresponding to audio input being spoken at a second, lower volume level). Audio signals that are modified may be modified using digital signal processing software and/or procedures, such as the present device's processor converting analog signals to digital form and then analyzing and numerically modifying the digital form prior to output.

Still in reference to FIG. 3, from block 310 the logic moves to block 312. At block 312 the logic transmits audio signals generated from user's the audio input, including any audio signals modified at block 310, to another device being used to facilitate the telephonic conference (such as via an Internet connection or over a telephone line) to a device of another participant.

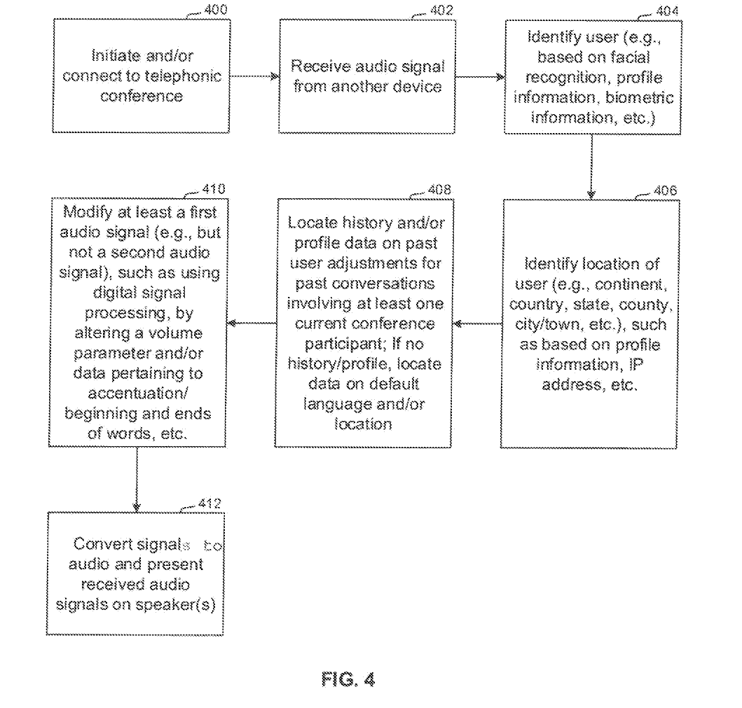

Reference is now made to FIG. 4. FIG. 4 shows example logic that may be undertaken by a device (referred to when describing FIG. 4 as the “present device”), such as the system 100 and/or a telephonic communication-enabled device, in accordance with present principles to alter an audio signal at the present device received from another telephonic communication-enabled device such as during a telephonic conference.

Beginning at block 400, the logic initiates and/or connects to a telephonic conference, such as a wireless telephone conference or a voice over internet protocol (VOIP) telephone conference. The logic then moves to block 402 where the logic receives one or more audio signals over the telephonic communication line/link, such as ones generated based on words spoken by a user of the other device.

Responsive to receiving one or more audio signals at block 402, the logic moves to block 404 where the logic may identify the user that provided the input that generated the audio signals received at the present device from the other device. The logic may identify the user a number of ways, such the ones similar to those described above in reference to block 304 of FIG. 3 and such as by performing voice recognition based on the received audio signals to identify a user associated with the voice.

From block 404 the logic then moves to block 406. At block 406 the logic may identify a location of the user of the other device. The location may be identified at least based on data similar to that discussed above in reference to block 306 and accessible to the present device, such as identifying the IP address of the other device (e.g., based on metadata received from the other device) and an area with which the IP address is associated.

After block 406, in some example embodiments the logic may, at block 408, locate history and/or profile data associated with the user of the other device, and/or associated with another identified participant in the telephonic conference for which history and/or profile data has been established and is accessible. The history and/or profile data may pertain to settings established during past conversations involving at least one of the participants in the current telephonic conference, such as those similar to the ones discussed above in reference to block 308. Also at block 408, if no such history and/or profile data is accessible, the logic may locate data for default settings to apply when processing audio signals for one or more participants in the telephonic conference.

After block 408, or directly from block 406 if a given set of instructions being executed by the present device do not instruct the present device to execute what was discussed above in reference to block 408, the logic moves to block 410. Based on the information identified and/or accessed at blocks 404-408, the logic at block 410 modifies at least a first audio signal from the other device, although it is to be understood that in some instances only some of the signals from the other device may be modified and hence the first audio signal may be modified while a second audio signal may not be modified. Audio signals that are modified may be modified using digital signal processing software and/or procedures, such as those discussed herein.

Concluding the description of FIG. 4, from block 410 the logic moves to block 412. At block 412 the logic converts audio signals received from the other device, including any audio signals modified at block 410, to audio and presents the audio at the present device using one or more speakers on the present device or otherwise accessible to the present device.

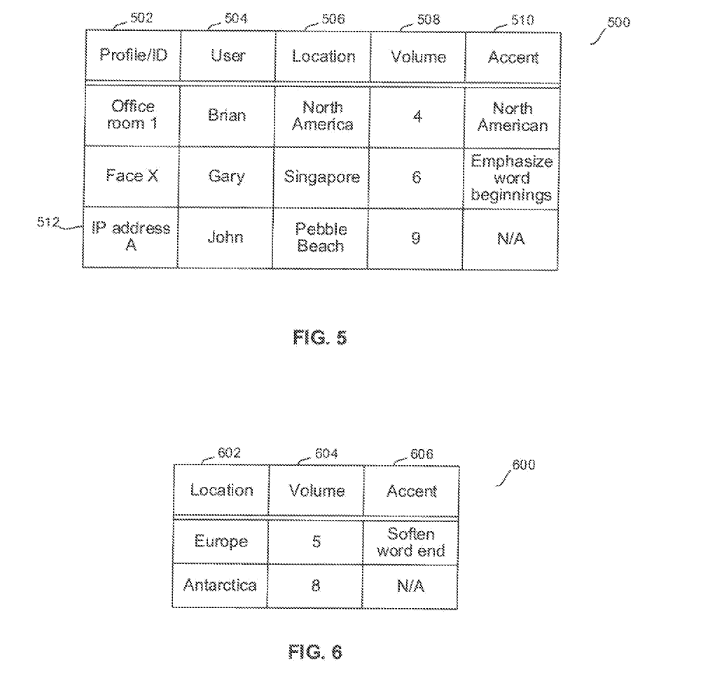

Before moving on to the description of FIG. 5, it is to be understood that operations such as those described above in reference to FIGS. 3 and 4 may be performed by a device controlling, hosting, and/or coordinating a telephonic conference, such as an Internet server hosting and coordinating an VOIP telephonic conference. Thus, such a coordinating device may alter audio signals received from devices of one or more participants of the telephonic conversation based on users and locations as discussed herein, and transmit them to respective other devices through which other participants are engaging in the telephonic conference.

Now describing FIG. 5, an example data table 500 is shown that may be accessed by a device, such as a device executing the logic of FIGS. 3 and/or 4, for identifying information useful for modifying audio signals as disclosed herein. The table 500 may at least in part establish, e.g., a history compiled over time as a user has made adjustments for the user and other participants during and after conference calls, and/or as may have been established when configuring conference settings as will be set forth further below.

Regardless, the table 500 includes a first column 502 listing user profiles, and/or other identifying information such as biometric recognition information and internet protocol (IP) addresses. The table 500 also includes a second column 504 listing, at each respective row, particular users respectively associated with information in the column 502 for the same row. Still further, the table 500 includes a location associated with each particular user in column 506, a predetermined volume level parameter in column 508, and a predetermined accent parameter and/or method of modifying audio signals in column 510.

Thus, as an example, after determining an IP address associated with a particular device being used to engage in a telephonic conference, a device undertaking the logic of FIG. 3 may access the data table 500 at block 304 and parse information from top to bottom in column 502 until a match for the IP address is identified in the table 500, such as at block 512. Responsive to identifying a match based on the information in block 512, the logic may then move horizontally over to column 504 to identify a user named John as the user as associated with that particular IP address. Then at block 306, the logic may move to the right again to column 506 to read the data stored in that block to identify that John is associated with the Pebble Beach location. Similar steps may be executed for identifying information in the other columns of table 500, for identifying the information shown in the table 600 of FIG. 6 (which will be described shortly), and/or for identifying information in other data tables and/or locations for use in accordance with present principles.

Now describing FIG. 6, another data table 600 is shown. The table 600 is understood to show default information for modifying audio signals in accordance with present principles that may not be participant-specific but instead may be based on participant location. The table 600 includes a first column 602 listing locations, in this case continents. The column 604 indicates default volume levels at which to present audio signals when the signals are received from another device on the respective continent listed in column 602 for that respective row. Still further, the table 600 includes a column 606 listing default accentuation information to apply to modify audio signals when received from a device on the respective continent listed in column 602 for that respective row.

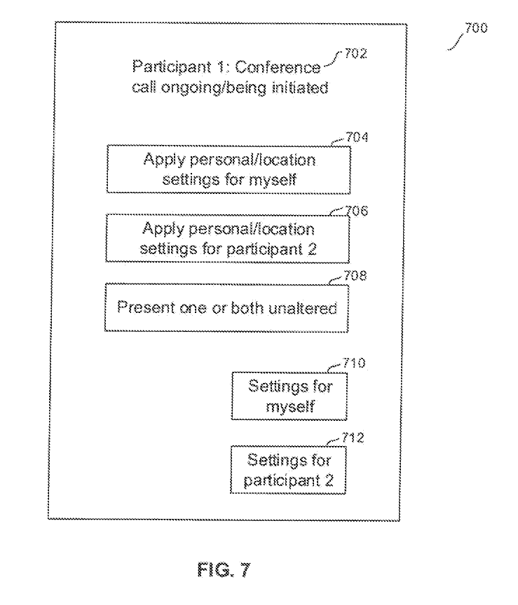

Continuing the detailed description in reference to FIG. 7, a user interface (UI) 700 presentable on a display of a device undertaking present principles is shown. The UI 700 includes information 702 regarding the participant using the device presenting the UI 700 and/or regarding the telephonic conference being engaged in. The UI 700 also includes a selector 704 selectable (e.g., using touch input) by a user to automatically without further user input apply personal and/or location-related settings/information for the user (such as may be found in a data table such as the table 500) when modifying audio signals generated based on audible input from the user that is to be transmitted to other devices being used to engage in the telephonic conference.

Still further, the UI 700 includes a selector 706 selectable by the user to automatically without further user input apply personal and/or location-related settings/information for another participant of the telephonic conference when modifying received audio signals for the other participant's voice to then audibly present them at the device presenting the UI 700. The UI 700 also shows a selector 708 selectable by the user to automatically without further user input decline to apply personal and/or location-related settings/information for the user and/or the other participant, and/or decline to modify audio signals as disclosed herein, when using the device to participate in the telephonic conference.

Moreover, in some embodiments the UI 700 may include a selector 710 selectable by the user to automatically without further user input present a settings UI for configuring settings to be applied to audio signals generated based on audible input from the user. The UI 700 may also include a selector 712 selectable by the user to automatically without further user input present a settings UI for configuring settings to be applied to audio signals associated with another participant of the current telephonic conference as well.

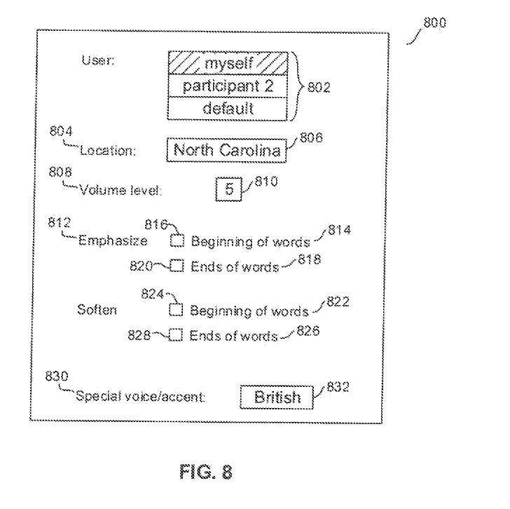

Now in reference to FIG. 8, an example settings UI 800 is shown that is presentable on a device undertaking present principles. The UI 800 includes selectors 802 respectively selectable to provide input to the device identifying a particular participant for which settings are to be and/or are being configured using the UI 800. As may be appreciated from the shading shown for the “myself” selector, in this example settings shown on the UI 800 when configured will be applied to the user of the device presenting the UI 800 (e.g., as opposed to ones to be applied to another participant of a telephonic conference (based on selecting the “participant 2” selector) and/or as default such as when the participant is unidentifiable (based on selecting the “default” selector)).

The UI 800 includes a first setting 804 for providing input of a location to be associated with the user, such as may be provided to text input box 806, as well as a second setting 808 for providing input of a volume level at which to present audio of the user (e.g., at other devices) based on modified audio signals, such as may be provided to number input box 810.

The UI 800 also includes another setting 812 for providing input to specify accentuations fir the user's voice to be applied by modifying audio signals as disclosed herein. Thus, the UI 800 shows an option 814 that is selectable using check box 816 to enable emphasizing of the beginnings of words spoken by the user, an option 818 that is selectable using check box 820 to enable emphasizing of the endings of words spoken by the user, an option 822 that is selectable using check box 824 to enable deemphasizing of the beginnings of words spoken by the user, and an option 826 that is selectable using check box 828 to enable deemphasizing of the ends of words spoken by the user

In addition to the foregoing, the UI 800 may also include a setting 830 for specifying a particular (e.g., regional) accent to apply for presentation of audio of the user. Input may be directed to input box 832 to specify an accent, such as, in the present example, British.

It may now be appreciated that present principles provide for altering audio of a telephonic conference, such as digitally detecting when a particular user has raised their voice and modulating volume parameters for audio signals for the user so that audio is presented at a (at least substantially) constant volume level despite the magnitude of the input varying. The tone of a specific person's voice may also be modulated (e.g., to be constant and/or monotone) by changing the volume, timing, and/or emphasis parameters used to present various portions of words from the person (e.g., word beginnings and ends, various syllables of words, etc.). For instance, a second word in a series of words may have its timing accelerated such that it is presented sooner after presentation of a first word than it was spoken after the user spoke the first word.

Moreover, settings for various participants and/or devices being used for telephonic conferencing (e.g., of three or more people/devices) may be adjusted by a device individually and automatically over time as participants make various adjustments to their call settings (such as volume level) during telephonic conferencing. When historical data is not available for a given participant and/or device, default settings may be applied, such as based on a given user's preferred language (as may be set in the operating system), as well as his or her IP-based location.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

While the particular MODIFICATION OF AUDIO SIGNAL BASED ON USER AND LOCATION is herein shown and described in detail, it is to be understood that the subject matter which is encompassed by the present application is limited only by the claims.

1. A device, comprising:
a processor; and
storage accessible to the processor and bearing instructions executable by the processor to:
receive at least one audio signal;
identify one or more of a user associated with at least one received audio signal and a location of the user; and
based at least in part on identification of one or more of the user and the location, modify at least one received audio signal by adjusting an accent of words spoken by the user from a first accent associated with a first geographic region to a second accent associated with a second geographic region different from the first geographic region.

2. The device of claim 1, wherein the device is a first device, and wherein the instructions are executable by the processor to:
transmit the modified audio signal to a second device different from the first device.

3. The device of claim 1, comprising at least one speaker, wherein the instructions are executable by the processor to:
present, using the speaker, audio output based on the audio signal.

4. The device of claim 1, wherein at least one received audio signal is modified using digital signal processing.

5. The device of claim 1, comprising a microphone, wherein the at least one audio signal is received from the microphone.

6. The device of claim 1, wherein the device is a first device, and wherein the at least one audio signal is received from a second device different from the first device.

7. (canceled)

8. The device of claim 1, wherein the instructions are executable by the processor to:
identify at least the location of the user, wherein the identification of the location comprises identification of one or more of: a continent, a country; and
based at least in part on identification of the location, modify at least one received audio signal.

9. (canceled)

10. The device of claim 1, wherein at least one received audio signal is modified at least in part by altering a volume parameter for the at least one received audio signal.

11. The device of claim 10, wherein the instructions are executable by the processor to:
receive plural audio signals for the user; and
alter a volume parameter for a first audio signal of the plural received audio signals and decline to alter a volume parameter for a second audio signal of the plural received audio signals s that a first portion of a first word spoken by the user has its volume adjusted while a second portion of the first word spoken by the user does not have its volume adjusted.

12. The device of claim 1, wherein at least one received audio signal is modified at least in part by altering the at least one received audio signal to produce an audible emphasis for a beginning of a first word to be produced from the at least one received audio signal and to produce an audible softening to an end of the first word.

13. (canceled)

14. A method, comprising:
receiving at least one audio signal at a device;
identifying one or more of a person associated with at least one received audio signal and a location of the person; and
based at least in part on the identifying of one or more of the person and the location, altering at least one received audio signal by adjusting an accent of words spoken by the person from a first accent associated with a first geographic region to a second accent associated with a second geographic region different from the first geographic region.

15. (canceled)

16. The method of claim 14, wherein the device is a first device, and wherein the method comprises:
transmitting the altered at least one received audio signal to a second device different from the first device.

17. (canceled)

18. An apparatus, comprising:
a processor; and
storage accessible to the processor and bearing instructions executable by the processor to:
facilitate a telephonic conference; and
alter at least a portion of audio for the telephonic conference based at least in part on one or more of a conference participant and a location of a conference participant;
wherein the telephonic conference is a first telephonic conference, and wherein at least the portion of audio for the first telephonic conference is altered based at least in part on a history pertaining to at least a second telephonic conference from the past in which at least one participant of the first telephonic conference participated.

19. The apparatus of claim 18, wherein the apparatus is a server that facilitates the telephonic conference between at least two other devices.

20. (canceled)

21. An apparatus, comprising:
a first processor;
a network adapter; and
storage bearing instructions executable by a second processor for:
facilitating a telephonic conference; and
modifying at least a portion of audio for the telephonic conference by adjusting an accent of words spoken by a conference participant from a first accent associated with a first geographic region to a second accent associated with a second geographic region different from the first geographic region;
wherein the first processor transfers the instructions over a network via the network adapter.

22. The method of claim 14, wherein the at least one received audio signal is altered to produce audio in which the voice of the person is monotone.

23. The method of claim 14, wherein the at least one received audio signal is altered to produce audio in which the timing of a first word as spoken by the person is accelerated relative to a second word spoken by the person.

24. The method of claim 14, comprising:
altering the at least one received audio signal to produce audio having an audible emphasis on a first portion of a first word but not a second portion of the first word, the first portion of the first word not being audibly emphasized when initially spoken.

25. The method of claim 14, comprising:
altering the at least one received audio signal to deemphasize a first portion of a first word that is spoken but not a second portion of the first word.

26. The apparatus of claim 21, wherein the instructions are executable by a second processor for:
output audio of the words spoken by the conference participant so that the audio of the words seem as though the words are spoken by a different person in a voice different from that of the conference participant.

27. The apparatus of claim 26, wherein the voice is that of a fictional character from audio video content.
